(19) United States
(12) Patent Application Publication
(10) Pub. No.: US 2025/0282126 A1
(43) Pub. Date: Sep. 11, 2025

(54) MULTILAYER PACKAGING FILM AND PROCESS

(71) Applicant: Amcor Flexibles North America, Inc., Neenah, WI (US)

(72) Inventors: James T. Schwindt, Oshkosh, WI (US); Frank E. Seckar, Oshkosh, WI (US); Tyler J. Theobald, Neenah, WI (US); Stephen J. Klein, Oshkosh, WI (US); Christopher M. Fraley, Greenville, WI (US)

(21) Appl. No.: 18/890,221

(22) Filed: Sep. 19, 2024

Related U.S. Application Data
(62) Division of application No. 16/598,825, filed on Oct. 10, 2019, now abandoned.

(51) Int. Cl. B32B 27/08; B32B 27/34; B32B 27/36

(52) U.S. Cl. CPC B32B 27/08; B32B 27/34; B32B 27/36; B32B 2367/00; B32B 2377/00; B32B 2439/70

(57) ABSTRACT

A multilayer packaging film and process is provided. Each layer of the film is positioned relative to each other layer in the following sequential order: (a) an exterior layer, (b) a first tie layer, (c) a first inner polyamide layer, (d) a barrier layer, (e) a second inner polyamide layer, (f) a second tie layer and (g) an interior layer of sealant material. The multilayer packaging film has a Thickness of from 0.50 mil to 3.0 mil. The multilayer packaging film has a Shrinkage Value of no more than five percent. The multilayer packaging film has a One-percent Secant Modulus of from about 100,000 psi to about 160,000 psi.

### CROSS REFERENCE TO RELATED APPLICATIONS

The present application is a divisional application of application Ser. No. 16/598,825 filed on Oct. 10, 2019 entitled “Multilayer Packaging Film and Process,” that is currently pending.

### TECHNICAL FIELD

This invention relates to multilayer packaging film for use in the perishable food industry, and in particular, using the film as a thin, transparent, barrier package itself to quickly and easily house and seal meat or cheese foods within the package and then enable removal from the package later with consistent separation between sealed layers where desired.

### BACKGROUND

It is generally known to utilize thermoplastic multilayer structures, such as films, sheets or the like, to package products. For example, typical products packaged with thermoplastic multilayer structures include perishable products, such as food. Specifically, meats and cheeses are typically packaged in thermoplastic structures. In addition, it is generally known that cook-in structures may be utilized to package food products, whereby the products are then heated to cook the food products contained within the packages. The properties needed for cook-in films and those not subject to cook temperatures can differ significantly. So, designing film for its intended use is important to achieve the desired properties, properties that often compete with one another and make obtaining all the desired features for a package difficult and often impossible, with existing technology.

Thus, a need exists for multilayer structures that may be utilized for packaging deli and deli-like meat or cheese products and other perishable food products not subject to cook temperatures. And, doing this such that the film and packages formed thereby have sufficient durability, strength and flexibility, in a thin yet barrier resistant structure, to enable quick and easy loading of the package. And preferably, the formed and loaded package is also heat-sealable so as to form packaging that can seal to itself or other similar structures.

Thicker structures often meet many of the durability and strength requirements, but are challenged on flexibility and tend to have a decrease in optical properties compared to relatively thinner structures, as well as have other disadvantages including higher costs and more waste after use. Also, a structure's thickness is directly related to haze. Thicker structures, therefore, tend to have an increase in haze, thereby contributing to a decrease in the clarity of the structures, and decreased ability to see the food that is within the package. A need, therefore, exists for coextruded multilayer structures having sufficient strength and durability, and that are significantly thin structures while maintaining superior optical properties, such as low haze and high clarity, as well as having sufficient durability, strength and flexibility. In addition, a need exists for coextruded multilayer structures that are orientable to provide packages that are significant barriers to the environment external to the sealed package with food inside. In addition, coextruded multilayer structures are needed having superior sealability as compared to known structures, while still maintaining great strength, durability, flexibility and optical properties. In addition, methods of making the multilayer structures and packages made therefrom are needed.

### SUMMARY

To address one or more of the above-noted needs, for example, there is provided an innovative multilayer packaging film. The film includes each layer positioned relative to each other layer in sequential order. In this way, there is (a) an exterior layer being a member from the group including polyamide, polypropylene, polyethylene, polyester and co-polymers of any of these, (b) a first tie layer, (c) a first inner polyamide layer, (d) a barrier layer, (e) a second inner polyamide layer, (f) a second tie layer and (g) an interior layer of sealant material. The multilayer packaging film has a Thickness of from 0.50 mil to 3.0 mil. The multilayer packaging film also has a Shrinkage Value of no more than five percent. And, the multilayer packaging film has a One-percent Secant Modulus of from about 100,000 psi to about 160,000 psi.

Also described herein is a multilayer packaging film process. The process includes coextruding each layer positioned relative to each other layer in the above-noted sequential order to form the multilayer packaging film. The process also includes forming the multilayer packaging film to a Thickness of from 0.50 mil to 3.0 mil, and even particular thicknesses noted below for different applications. There is also imparting a Shrinkage Value of no more than five percent to the multilayer packaging film. And, another step in the process is imparting a One-percent Secant Modulus of from about 100,000 psi to about 160,000 psi to the multilayer packaging film.

Some embodiments are directed to the forming of a package, and where the package is the multilayer packaging film, with the interior layer of the film sealed to itself in a circular formed relationship and/or folded over relationship or cut and superimposed in placed relationship. In this regard, then in some aspects the invention further concerns adhering the second inner polyamide layer to the interior layer with a Bond Strength greater than a Seal Strength of the interior layer sealed to itself. Even more preferably then, second inner polyamide layer can be adhered to the interior layer with a Bond Strength of at least 250 g/inch. Yet further, and depending on the desired end use, the sealant material may be peelable to assist in separating the interior layer of the film when sealed to itself to form the package.

Some embodiments of the process involve biaxially orienting the multilayer packaging film, annealing the multilayer packaging film, doing both of these steps, and even possibly doing so simultaneously, and preferably having coextruding, biaxially orienting and annealing occur in a continuous in-line process, and even more preferably doing these in a triple bubble process.

### BRIEF DESCRIPTION OF THE DRAWINGS

The invention may be more completely understood in consideration of the following detailed description of various embodiments of the invention in connection with the accompanying drawings, in which:

FIG. 1 is a cross-sectional view of an embodiment of the multilayer packaging film of the invention;

FIG. 2 is a top view of an embodiment of a package formed from the multilayer packaging film seen in FIG. 1;

FIG. 3 is a cross-sectional and enlarged view of the portion of the package taken along the line 3-3 in FIG. 2 and in FIG. 4;

FIG. 4 is a top view of an alternate embodiment of a package formed from the multilayer packaging film seen in FIG. 1;

FIG. 5 is a cross-sectional view of another embodiment of the multilayer packaging film of the invention; and

FIG. 6 is a cross-sectional view of still another embodiment of the multilayer packaging film of the invention.

The drawings show some but not all embodiments. The elements depicted in the drawings are illustrative and not necessarily to scale, and the same (or similar) reference numbers denote the same (or similar) features throughout the drawings.

### DETAILED DESCRIPTION

As used herein, “adjacent” means that there is no intervening material between the components.

As used herein, the terms “adhere,” “adherence,” “adhesion”, and formatives thereof, as applied to film layers or other components of the present invention, are defined as affixing of the subject layer surface to another surface, with or without adhesive, and such that the layers or components are attached to each other and would require a force to separate them.

As used herein the terms “sealant”, “sealant material”, “sealant layer” refer to a film layer, or layers, involved in the sealing of the film: 1) to itself or 2) to another film layer of the same film. In general, the sealant material is a surface layer, that is, an exterior or an interior layer of any suitable thickness, that provides for the sealing of the film to itself or another layer or film or component. The sealant material may be homogenous or a blend. For example, the blend could be 40% to 70% EVA plus 0% to 21% mLLDPE plus 25% to 35% polybutene.

The term “seal” and its formatives, as used herein, refers to the union of a surface (or portion thereof) of one film to a surface (or portion thereof) of another film or two different portions of a surface of the same film (e.g., sealing surface 32 to sealing surface 32). Seals may be formed by any known method including heat sealing, ultrasonic sealing, RF welding, etc.

As used herein, the terms “ethylene vinyl alcohol copolymer”, “EVOH copolymer”, and “EVOH”, refer to copolymers comprised of repeating units of ethylene and vinyl alcohol. Ethylene vinyl alcohol copolymers may be represented by the general formula: [(CH2-CH2)n-(CH2-CH(OH))m]. Ethylene vinyl alcohol copolymers may include saponified or hydrolyzed ethylene vinyl acetate copolymers. In commercial grades of EVOH, the extent of saponification is very high (generally at least 97 percent), such that the presence of any unsaponified vinyl acetate groups is typically ignored. The EVOH composition is usually expressed in terms of its ethylene content and for commercial grades used in packaging applications, the ethylene content may range from 27 mole percent to 48 mole percent, though even broader compositions are produced for other applications. EVOH is commercially available in resin form with various percentages of ethylene. One source of suitable EVOH copolymers is available from Kuraray America, Inc, Houston, TX, USA, under the trade name of EVAL.

Further, the “ethylene vinyl alcohol copolymer” or “EVOH” that has been previously described is known to be a highly effective oxygen barrier having a direct relationship between ethylene content and melting point. For example, EVOH having a melting point of about 158 degrees Celsius corresponds to an ethylene content of 48 mole percent and a melting point of about 175 degrees Celsius corresponds to an ethylene content of 38 mole percent. EVOH copolymers having lower or higher ethylene contents may also be employed. With increasing ethylene content, the melting point is lowered. Also, EVOH copolymers that have increasing mole percentages of ethylene generally have greater gas permeabilities that are dependent on factors such as relative humidity and the nature of the permeating gas. It is expected that processability and orientation would be facilitated at higher ethylene contents; however, gas permeabilities, particularly with respect to oxygen, may become undesirably high for certain packaging applications that are sensitive to microbial growth in the presence of oxygen. Conversely lower ethylene contents may have lower gas permeabilities, but processability and orientation may be more difficult. Further, a person having ordinary skill in the art would understand that a film including an EVOH layer that is relied upon as a gas barrier would generally not be blended and is 100 percent EVOH. However, some applications include EVOH blended with a polyolefin at 50 percent or less of EVOH by weight of the barrier layer. For example, the gas barrier layer may include 40, 30, 20, or even 10 percent EVOH by weight to provide gas barrier properties.

As used herein, the terms “polyethylene” or “PE” refers to a polymer whose basic structure is characterized by the chain: (CH2-CH2-)ₙ. The term “polyethylene” includes homopolymers and copolymers of ethylene. Polyethylene homopolymer is generally described as being a solid which has a partially amorphous phase and partially crystalline phase with a density of between 0.870 to 0.980 grams per cubic centimeter. The relative crystallinity of polyethylene is known to affect its physical properties. The amorphous phase imparts flexibility and high impact strength while the crystalline phase imparts a high softening temperature and rigidity.

There are several broad categories of polymers and copolymers referred to as “polyethylene”. Placement of a particular polymer into one of these categories of polyethylene is frequently based upon the density of the polyethylene and often by additional reference to the process by which it was made since the process often determines the degree of branching, crystallinity and density. In general, the nomenclature used is nonspecific to a compound but refers instead to a range of compositions. This range often includes both homopolymers and copolymers.

“High density polyethylene” (HDPE) is ordinarily used in the art to refer to both (a) homopolymers of densities between about 0.960 to 0.980 grams per cubic centimeter and (b) copolymers of ethylene and an a-olefin (usually 1-butene or 1-hexene) that have densities between 0.940 and 0.958 grams per cubic centimeter. HDPE includes polymers made with Ziegler or Phillips type catalysts and is also said to include high molecular weight polyethylene.

“Medium density polyethylene” (MDPE) typically has a density from 0.928 to 0.940 grams per cubic centimeter. Medium density polyethylene includes linear medium density polyethylene (LMDPE).

Another grouping of polyethylene is “high pressure, low density polyethylene” (LDPE). LDPE is used to denominate branched homopolymers having densities between 0.915 and 0.930 grams per cubic centimeter. LDPEs typically contain long branches off the main chain (often termed “backbone”) with alkyl substituents of 2 to 8 carbon atoms.

“Linear low density polyethylene” (LLDPE) are copolymers of ethylene with alpha-olefins having densities from 0.915 to 0.940 grams per cubic centimeter. The alpha-olefin utilized is usually 1-butene, 1-hexene, or 1-octene and Ziegler-type catalysts are usually employed (although Phillips catalysts are also used to produce LLDPE having densities at the higher end of the range, and metallocene and other types of catalysts are also employed to produce other well-known variations of LLDPEs). A LLDPE produced with a metallocene or constrained geometry catalyst is often referred to as “mLLDPE”.

Other examples of polyethylene copolymers include, but are not limited to, ethylene vinyl acetate copolymer (EVA), ethylene methyl methacrylate copolymer (EMMA), ethylene-methacrylic acid (EMAA), ethylene acrylic acid (EAA), and cyclic olefinic copolymers (COC). Other polymers may include ionomers, and functional group-modified polymers including, e.g., anhydride-modified polyolefins.

As used herein, the terms “polyamide” or “PA” or “nylon” refer to homopolymers or copolymers having recurring amide linkages and may be formed by any method known in the art. Recurring amide linkages may be formed by the reaction of one or more diamines and one or more diacids. Non-limiting examples of suitable diamines include 1,4-diamino butane, hexamethylene diamine, decamethylene diamine, metaxylylene diamine and isophorone diamine. Non-limiting examples of suitable diacids include terephthalic acid, isophthalic acid, 2,5-furandicarboxylic acid, succinic acid, adipic acid, azelaic acid, capric acid and lauric acid.

Polyamides may also be formed by the ring-opening polymerization of suitable cyclic lactams like ε-caprolactam, ω-undecanolactam and ω-dodecalactam.

Non-limiting examples of suitable polyamides include poly(ε-caprolactam) (nylon 6), poly(ω-undecanolactam) (nylon 11), poly(ω-dodecalactam) (nylon 12), poly(hexamethylene adipamide) (nylon 6,6), poly(hexamethylene adipamide-co-caprolactam) (nylon 66/6), poly(caprolactam-co-hexamethylene adipamide) (nylon 6/66), poly(caprolactam-co-hexamethylene azelamide) (nylon 6/69), poly(m-xylylene adipamide) (MXD6) and poly(hexamethylene terephthalamide-co-hexamethylene isophthalamide) (nylon 6I/6T).

As used herein, the term “polyester” refers to homopolymers and copolymers having recurring ester linkages which may be formed by any method known in the art. Recurring ester linkages may be formed by the reaction of one or more diols with one or more diacids. Non-limiting examples of suitable diols include ethylene glycol, diethylene glycol, 1,3-propanediol, 1,4-butanediol, resorcinol, 1,4-cyclohexanedimethanol, 2,2,4,4-tetramethyl-1,3-cyclobutanediol, and polyoxytetramethylene glycol. Non-limiting examples of suitable diacids include terephthalic acid, isophthalic acid, 2,6-naphthalene dicarboxylic acid, 2,5-furandicarboxylic acid, 1,4-cyclohexane dicarboxylic acid, trimellitic anhydride, succinic acid, adipic acid and azelaic acid.

Non-limiting examples of suitable polyesters include poly(ethylene terephthalate) (PET), poly(ethylene terephthalate-co-cyclohexanedimethanol terephthalate) (PETG), poly(butylene terephthalate) (PBT), poly(ethylene naphthalate) (PEN), poly(ethylene furanoate) (PEF), poly(propylene furanoate) (PPF) and poly(butylene adipate-co-terephthalate) (PBAT).

Suitable polyesters may also be formed by the ring-opening polymerization of suitable cyclic monomers like lactides to form, for example, poly(lactic acid) (PLA), glycolides to form, for example, poly(glycolic acid) (PGA) and lactones to form, for example, poly(caprolactone) and poly(butyrolactone).

Suitable polyesters may also be formed by the direct condensation reaction of alpha hydroxy acids. For example, PGA may be formed by the condensation reaction of glycolic acid.

Suitable polyesters may also be synthesized by microorganisms. Examples of suitable polyesters include various poly(hydroxy alkanoates) like poly(hydroxy butyrate) (PHB) and poly(hydroxy valerate) (PHV).

As used herein, the term “polypropylene” or “PP” refers to a plastomer, homopolymer or copolymer having at least one propylene monomer linkage within the repeating backbone of the polymer. The propylene linkage may be represented by the general formula: [CH₂—CH(CH₃)]ₙ. Such polypropylene may be a polypropylene impact copolymer, a polypropylene random copolymer, or a polypropylene homopolymer, may be syndiotactic or isotactic, or may or may not be clarified.

As used herein, the term “copolymer” refers to a polymer product obtained by the polymerization reaction or copolymerization of at least two monomer species. Copolymers may also be referred to as bipolymers. The term “copolymer” is also inclusive of the polymerization reaction of three, four or more monomer species having reaction products referred to terpolymers, quaterpolymers, etc.

The multilayer packaging film 10 can include one or more adhesive layers, also known in the art as “tie layers”, which can be selected to promote the adherence of adjacent layers to one another in a multilayer film. The terms “tie layer” or “adhesive layer”, as used herein, refer to a material placed on one or more layers, partially or entirely, to promote the adhesion of that layer to another surface. Preferably, adhesive layers are positioned between two layers of a multilayer film to maintain the two layers in position relative to each other and prevent undesirable delamination. Unless otherwise indicated, a tie layer or an adhesive layer can have any suitable composition that provides a desired level of adhesion with the one or more surfaces in contact with the adhesive layer material. Optionally, a tie layer or adhesive layer placed between two layers may include components of each of the layers to promote simultaneous adhesion of the adhesive layer to both the layers, each on opposite sides of the adhesive layer.

Tie layers, as generally known by a person of ordinary skill in the art, may be incorporated into the multilayer packaging film 10 as appropriate. Multilayer films can comprise any suitable number of tie or adhesive layers of any suitable composition. Various adhesive layers are formulated and positioned to provide a desired level of adhesive between specific layers of the film according to the composition of the layers contacted by the tie layers. Non-limiting examples of commercial materials that would be suitable for use as the tie layers of the invention, and preferably so for the second tie layer, are as follows: SF755A, NF911E, SF730E, and SE810, all of Mitsui Chemicals America, Inc. of Rye Brook, NY 10573.

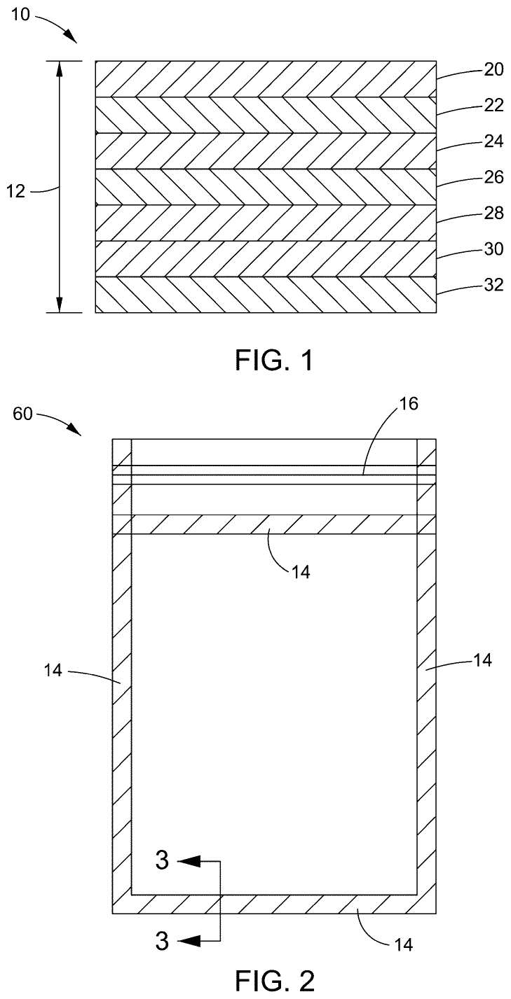

In accordance with the practice of at least one embodiment of the invention, as seen in FIG. 1, there is a multilayer packaging film 10. In the film, each layer is positioned relative to each other layer in sequential order. There is an exterior layer 20 being a member from the group including polyamide, polypropylene, polyethylene, polyester and co-polymers of any of these. Next to this is adhered a first tie layer 22. Adhered to layer 22 is a first inner polyamide layer 24. To this is adhered a barrier layer 26. For example, and preferably, barrier layer 26 can be EVOH. To layer 26 is adhered a second inner polyamide layer 28. Next, is adhered a second tie layer 30. To layer 30 is adhered an interior layer 32 of sealant material. In one embodiment, preferably second inner polyamide layer 28 adheres to the interior layer 32 directly via the second tie layer 30. In this way, which is contrary to that taught in FIG. 6 (described below), less material can be used and yet still achieve the desired adherence between these adjacent layers for great film integrity in use.

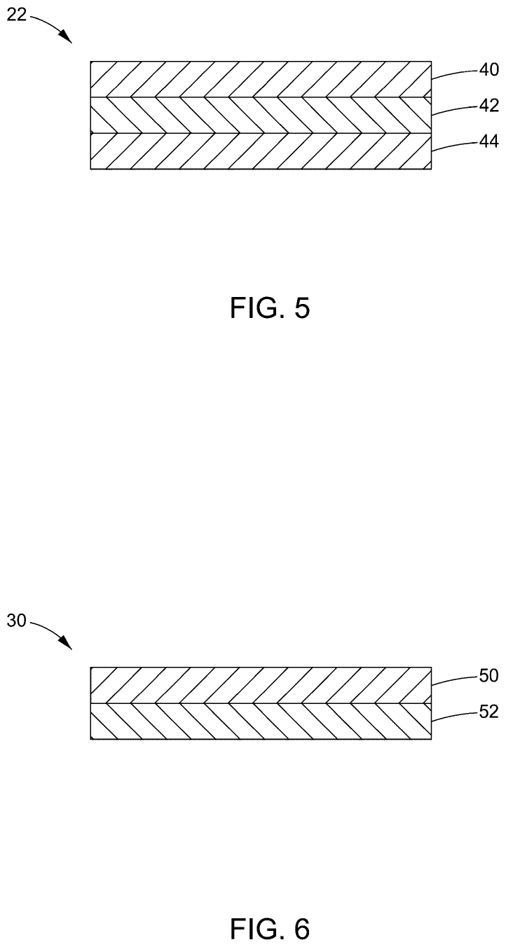

In some embodiments, for example, the multilayer film may include more than one tie layer in first tie layer 22. Referring to FIG. 5, for example, a first tie layer 40 is adhered next to a bulk layer 42 such as polyethylene, and then another tie layer 44 adhered thereto, and then layer 44 would adhere to first inner polyamide layer 24. In other embodiments, for example and as seen in FIG. 6, a second tie layer 50 is adhered to a bulk layer 52 such as polyethylene, and then layer 52 would adhere to interior layer 32.

In addition to the importance of the relationship of the layers of the multilayer packaging film, is formation and performance of the film as a whole based on these layers. Regarding formation, the multilayer packaging film must have a Thickness 12 of from 0.50 mil to 3.0 mil. Additionally, preferably, depending on the desired use for the film, the Thickness is from about 0.75 mil to about 1.75 mil (and exemplified in the FIG. 2 configuration) or the Thickness is from about 1.25 mil to about 2.5 mil (and exemplified in the FIG. 4 configuration). As discussed above, the thinner a film is the better for a variety of reasons, but that often comes at the detriment to one or more performance characteristics. However, unlike before possible and as explained further herein, the inventors have developed this thin film of the invention that still achieves desired strength, durability, flexibility and/or optical properties. The Thickness 12 is determined as known by one of ordinary skill in the art, and preferably by using the following test: ASTM F2251-03.

In regards to performance, the multilayer packaging film must have a Shrinkage Value of no more than five percent, and the film having this feature in both its MD and TD dimensions. Preferably the Shrinkage Value is no more than three percent, and more preferably no more than one percent. In these ways, and without being limited to a theory of understanding, this can be advantageous because a packaging machine is designed to run with a film that does not shrink when it is heat sealed. If the film shrinks too much when heat sealed, the material may melt too much and cause poor appearance, further processability drawbacks on the machine, and/or poor seals. The film needs to have the dimensional stability for running on the machine and forming ability; whether cold forming or thermoforming. Films without such a Shrinkage Value are not acceptable for the invention and lead to unfavorable machine conditions and unacceptable processability. The Shrinkage Value is determined as known by one of ordinary skill in the art, and preferably by using the following test: ASTM D2732-03. Shrinkage Value is defined to be the value obtained by measuring unrestrained (i.e., free) shrink of a 10 cm square sample immersed in water at 90° C. for five seconds. Four test specimens are cut from a given sample of the film to be tested. The specimens are cut into squares of 10 cm length in the machine direction by 10 cm length in the transverse direction. Each specimen is completely immersed for 5 seconds in a 90° C. water bath. The specimen is then removed from the bath and the distance between the ends of the shrunken specimen is measured for both the machine (MD) and transverse (TD) directions. The difference in the measured distance for the shrunken specimen and the original 10 cm side is multiplied by ten to obtain the percent of shrinkage for the specimen in each direction. The shrinkage of four specimens is averaged for the MD shrinkage value of the given film sample, and the shrinkage for the four specimens is averaged for the TD shrinkage value.

As another critical performance characteristic, the multilayer packaging film 10 must have a One-percent Secant Modulus of from about 100,000 psi to about 160,000 psi, and the film having this feature in both its MD and TD dimensions. For example, the film of the invention is now able to achieve this Modulus range, while also employing such a low thickness and desired Bond Strength, as has not been possible with prior films. That is, thickness and Bond Strength usually move in the same direction relative to one another such that a reduced thickness means a reduced Bond Strength, and vice versa. The invention is advantageous in that it is able to move these parameters in opposite directions and enable a desired One-percent Secant Modulus range for a low thickness film and where a high Bond Strength can still be obtained. Further, this can be important because One-percent Secant Modulus is indicative of the forming and processability of the film on the packaging machine, and now it can be accomplished more effectively and efficiently than ever before. Some ways to accomplish this are explained below in regards to the process embodiments for forming the film of the invention and the amount of orientation to obtain the desired One-percent Secant Modulus. Still further, the desired modulus range gives a high amount of strength, but yet having a less amount of stretch versus prior art films. And thus, the film of the invention is imparted with the right amount of stretch to form around the forming collar of the packaging machine for proper processability and also with the formation of a shallow pocket (˜15-25 mm) in the film that is desirable for the film used to make package 60 referred to as a “deli pack”, for example. In another example, the film may be a thermoformable film that may be formed into trays or other rigid packaging components where the film may also have pockets formed therein at even a deeper draw than cold forming. The One-percent Secant Modulus is determined as known by one of ordinary skill in the art, and preferably by using the following test: ASTM D882-12.

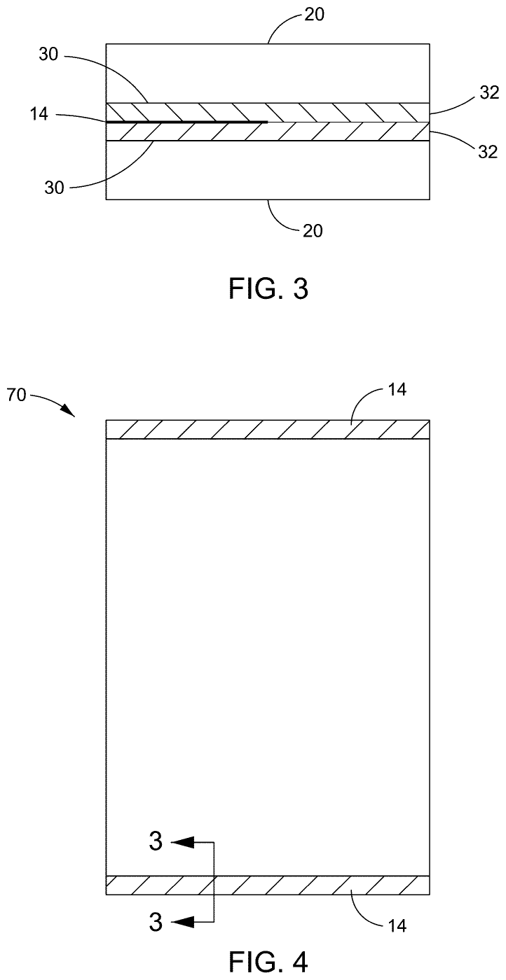

In use, the film 10 can be formed, for example, into a package 60 as seen in FIG. 2 or a package 70 as seen in FIG. 4, and both also in reference to FIG. 3. The package 60 can have sealed zones 14, often formed by heat and/or pressure sealing, that causes the multilayer packaging film to have interior layer 32 sealed to itself. This can be by cutting and placing pieces of film 10 on top of each other (as in FIG. 2). The package 60 is referred to as a “deli pack” and it can be easily filled with food product like sliced meats or cheeses that are sealed therein, and then it is ready for quick consumer visual inspection and grabbing on the way to the check-out line. Alternately, this can be by forming into a ring (as in FIG. 4) or folding of film 10 onto itself (not specifically shown but a combination of that seen in FIGS. 2 and 4). For example, a “tube” package can be formed as a blown film tube that is collapsed on itself so the interior layer of sealant material is the innermost layer of the tube (as in FIG. 4). A portion of the tube can be cut in the transverse direction and sealed at one end to form a bag. The contents can be inserted via the opposite end and then the opposite end sealed to form a closed package. This tube form can be used with bulk food product such as forty pound cheese logs or loafs. It should be further noted, the packages described here are non-limiting and formed packages may include other features including and not limited to gussets, mechanical closures (zip closures, mechanical fasteners) and other structural configurations, as long as they do not negate the features taught and disclosed as the invention.

In all these uses, the sealed relationship must be sufficient to seal the packaging internal contents (e.g., food stuffs as described earlier) from the external environment. In one embodiment, the layer of sealant material 32 can be peelable so that separation occurs, when desired by the user, cleanly at the outer most surfaces of each adjacent layer 32 without any materially visible destruction of a layer. Alternately, the layer of sealant material 32 can be destroyed at its outer surface so that separation occurs, when desired by the user, within the layers 32 so they visibly appear torn and destroyed at their outer surfaces when access to the package is gained. While layers 32 may be destroyed, in this embodiment of the invention it is still important that the interface between layer 28 and layer 32 is maintained intact, that is, that layer 28 is not materially visible destroyed by the act of separating layer 32 from layer 32.

To help achieve the separation between sealed layers 32 when desired, at least in part, preferably the second inner polyamide layer 28 adheres to the interior layer 32 via second tie layer 30 with a Bond Strength greater than a Seal Strength of the interior layer 32 sealed to itself via adjacent layer 32. In practice, for the peelable film (e.g., package 60 referred to as a “deli pack”), the film will peel open such that the layers separate in the appropriate area, giving a clean, smooth appearance (desired peel). Undesired characteristics such as the film peeling apart in a stringy manner, the film not peeling consistently when peeling it open, or the failure mode becomes further away from the desired tear point (farther away from tie layer interface), are avoided with the film of the invention. Alternately or additionally, to help achieve this at least in part, preferably, the second inner polyamide layer 28 adheres to the interior layer 32 via second tie layer 30 with a Bond Strength of at least 250 g/inch. In practice, for this higher Bond Strength sealed film (e.g., package 70 referred to as a “tube” package), it is generally not a peelable film system. The film here needs sufficient Bond Strength for it to pass through end-use applications (packaging machine, weight of contents or the like), as determined by its peak Seal Strength when sealed to self that is important here. And, as a much thinner film than what is possible without the invention, this provides even more value due to use of less materials and thus cost savings.

Stated further, for example, the film of the invention is now able to achieve this sealed to itself/self relationship, while also employing desired separation ability, as has not been possible with prior films. That is, ability to control where separation occurs between sealed together layers is substantially reduced with thin films, and in particular such a thin film as the invention, because control and thickness move in the same direction relative to one another such that a reduced thickness means reduced control, and vice versa. The Bond Strength and Seal Strength are determined as known by one of ordinary skill in the art, and preferably by using the following tests: (i) ASTM F88/F88M-09 (at 300 deg. F for 1 second under 40 psi) for determining Seal Strength of layer 32 to itself (e.g., FIG. 3) and (ii) ASTM F904-98 for determining Bond Strength between second inner polyamide layer 28 and interior layer 32 via tie layer 30.

In various non-limiting embodiments, the multilayer packaging film 10 may be like the structures listed below:
PA/tie/bulk PE/tie/PA/EVOH/PA/second tie/bulk PE/PE sealant
PA/tie/bulk PE/tie/PA/EVOH/PA/second tie/bulk PE/sealant material blend
PA/tie/PA/EVOH/PA/second tie/PE sealant
PA/tie/bulk PE/tie/PA/EVOH/PA/second tie/bulk PE/PE peelable sealant
PA/tie/PA/EVOH/PA/second tie/PE peelable sealant blend
PA/tie/PA/EVOH/PA/second tie/PE peelable sealant

As used herein, the terms “coextruded” or “coextrusion” refer to the process of extruding two or more polymer materials through a single die with two or more orifices arranged so that the extrudates merge and weld together into a laminar structure before chilling (i.e., quenching). Examples of coextrusion methods known in the art include but are not limited to blown film (annular) coextrusion, slot cast coextrusion and extrusion coating. The flat die or slot cast process include extruding polymer streams through a flat or slot die onto a chilled roll and subsequently winding the film onto a core to form a roll of film for further processing.

As used herein, the term “blown film” refers to a film produced by the blown coextrusion process. In the blown coextrusion process, streams of melt-plastified polymers are forced through an annular die having a central mandrel to form a tubular extrudate. The tubular extrudate may be expanded to a desired wall thickness by a volume of fluid (e.g., air or other gas) entering the hollow interior of the extrudate via the mandrel and then rapidly cooled or quenched by any of various methods known in the art.

As used herein, the term “orient” and formatives thereof refers to a film, sheet, web, etc. that has been elongated in at least one of the machine direction or the transverse direction. Such elongation is accomplished by procedures known in the art. The oriented film may be extruded using either flat or annular die type processes.

Orientation may be mono-directional (machine direction or transverse direction), or bi-directional (also called “bi-axial” or “bi-axially”) stretching of the film, increasing the machine direction and/or transverse direction dimension and subsequently decreasing the thickness of the material. Bi-directional orientation may be imparted to the film simultaneously or successively. Stretching in either or both directions is subjected to the film in the solid phase at a temperature just below the melt temperature of the polymers in the film. In this manner, the stretching causes the polymer chains to “orient”, changing the physical properties of the film. At the same time, the stretching thins the film. The resulting films are thinner and can exhibit significant changes in mechanical properties such as toughness, heat resistance, stiffness, tear strength and barrier, and these impacting the desired characteristics of Thickness, Shrinkage Value and/or One-percent Secant Modulus.

The invention is also directed to a process for making the multilayer packaging film 10. This includes first coextruding each layer positioned relative to each other layer in the order discussed above to form the multilayer packaging film. Another step is forming the multilayer packaging film to a Thickness of from 0.50 mil to 3.0 mil, and preferably where the Thickness is from about 0.75 mil to about 1.75 mil or alternately from about 1.25 mil to about 2.5 mil. Still another step is imparting a Shrinkage Value of no more than five percent to the multilayer packaging film. Finally, the process requires imparting a One-percent Secant Modulus of from about 100,000 psi to about 160,000 psi to the multilayer packaging film.

In one embodiment, one or more of these desired performance characteristics can be achieved where at least one, and preferably both, imparting steps include orienting the multilayer packaging film, and even more preferably biaxially orienting the film. As another way to achieve one or more of these desired performance characteristics, at least one of the imparting steps, and preferably both imparting steps, include annealing the multilayer packaging film. And most preferably, both imparting steps include biaxially orienting the multilayer packaging film and annealing the multilayer packaging film. In another embodiment of the invention, the steps of coextruding, biaxially orienting and annealing occur in a continuous in-line process. And, in yet another embodiment, the multilayer packaging film 10 is formed by a triple bubble process (as explained in more detail below).

Non-limiting examples of procedures to form the film of the invention include the single bubble blown film extrusion process and the slot cast sheet extrusion process with subsequent stretching, for example, by tentering, to provide orientation. Another example of such procedure is the trapped bubble, double bubble or triple bubble processes; see, for example, U.S. Pat. Nos. 3,546,044 and 6,511,688, each of which is incorporated in its entirety in this application by this reference. In the trapped bubble, double bubble or triple bubble processes, an extruded primary tube leaving the tubular extrusion die is cooled, collapsed and then, if desired, oriented by reheating, reinflating to form a secondary bubble and recooling, and then, if desired, further oriented (or relaxed) by reheating, reinflating to form a tertiary bubble and recooling. Doing this yet again then achieves the triple bubble process and its benefits. Transverse direction orientation may be accomplished by inflation, radially expanding the heated film tube. Machine direction orientation may be accomplished by the use of nip rolls rotating at different speeds, pulling or drawing the film tube in the machine direction. The combination of elongation at elevated temperature followed by cooling causes an alignment of the polymer chains to a more parallel configuration, thereby improving the mechanical properties of the multilayer packaging film to have those desired for the invention.

For example, the Shrinkage Value may be reduced and the One-percent Secant Modulus may be increased, both these despite a rather thin film, and as preferred for the invention, if the oriented film is first annealed or heat-set by heating to an elevated temperature, preferably to an elevated temperature which is above the glass transition temperature and below the crystalline melting point of the polymer comprising the film, and for a desired dwell time. This reheating/annealing/heat-setting step also provides a polymeric film web of uniform flat width. The polymeric film may be annealed (i.e., heated to an elevated temperature) either in-line with (and subsequent to) or off-line (and in another process) from the orientation process. And, these may occur multiple times, if needed, to obtain the desired performance characteristics of the layers in, and the overall multilayer packaging film. More particularly, for example, and adjusting these as one of ordinary skill in the art would know to do in combination with the teachings herein, to achieve the desired performance characteristics of the invention a manufacturer will: (i) increase or decrease the Blow Up Ratio (a well-known term in this art) and/or the Draw Ratio (a well-known term in this art) in the orienting section of the blown film forming machine, (ii) increase or decrease the orienting temperature and cooling settings impacting the film during formation, and (iii) increase or decrease annealing relaxation percentage and temperature impacting the film during formation.

In other aspects of the process, and as seen in FIGS. 2 and 4, the multilayer packaging film 10 is formed into a package with the multilayer packaging film where the interior layer is sealed to itself. For reasons discussed previously, preferably the process includes adhering the second inner polyamide layer to the interior layer via the second tie layer with a Bond Strength greater than a Seal Strength of the interior layer sealed to itself. For example, this can be adhering the second inner polyamide layer to the interior layer via the second tie layer with a Bond Strength of at least 250 g/inch. In these ways, the use of the package gets to take advantage of being sealed to itself when desired to seal contents inside the package and openable at the sealed area when access to the contents is desired. The sealed portion will either separate cleanly from each other if the sealant material is peelable, or the sealed together films will rupture at the interior layer of material without damaging the adjacent second tie layer or its adjacent second inner polyamide layer.

To further demonstrate the unique aspects of the invention and distinguish it from existing films, the inventors performed a number of tests on embodiments of the invention and on prior art existing films. The tests performed and their results are in the below in TABLE 1. In the table is depicted 14 samples, where samples 8 and 9 are the invention with sample 8 being preferred for use like package 60 (FIG. 2) and sample 9 preferred for use like package 70 (FIG. 4). Samples 1-7 and 10 are Amcor Limited (located in Neenah, WI) commercially available prior art films. Samples 11 and 13 are Sealed Air Corp (located in Charlotte, NC) commercially available prior art films. Sample 12 is a Shields Novolex (located in Yakima, WA) commercially available prior art film. And, sample 14 is a Sudpack Oak Creek Corp (located in Oak Creek, WI) commercially available prior art film. Samples 12-14 are like package 70 (FIG. 4) in packaging configuration. Each film was tested according to the tests identified there and per the tests/protocol described herein. Values in the table are in noted units identified by the test. NA means not applicable for that film. CNS means cannot separate the stated layers as noted in the chart lower legend, and such that the stated layers are bonded together with a force of at least 250 g/inch but also not so high that the force cannot be measured. That is, for the CNS value, the adjoining layers have a Bond Strength (as measured using the test herein) of at least 250 g/inch and thus the film itself will not open or fail at the stated seal location unless and until the film is peeled open in peelable embodiments or cut open or a tear cut is employed in in non-peelable embodiments.

TABLE 1

| | Sample number | | | | | | | | | | | | | |
|---|---|---|---|---|---|---|---|---|---|---|---|---|---|---|
| | 1 | 2 | 3 | 4 | 5 | 6 | 11 | 7 | 10 | 8 | 9 | 13 | 12 | 14 |
| One-percent | 30000 | 30000 | 130000 | 240000 | 225000 | 82000 | 99600 | 125000 | 30000 | 135000 | 130000 | 80000 | 80000 | 70000 |
| Secant | | | | | | | | | | | | | | |
| Modulus | | | | | | | | | | | | | | |
| (psi; MD) | | | | | | | | | | | | | | |
| One percent | 30000 | 30000 | 30000 | 167000 | 225000 | 76000 | 94000 | 105000 | 30000 | 115000 | 120000 | 70000 | 70000 | 60000 |
| Secant | | | | | | | | | | | | | | |
| Modulus | | | | | | | | | | | | | | |
| (psi; TD) | | | | | | | | | | | | | | |
| Thickness | 2 | 1.25 | 2 | 1.65 | 1.9 | 1.75 | 1 | 1.15 | 1.75 | 1.5 | 2 | 3 | 3.5 | 4.5 |
| (mil) | | | | | | | | | | | | | | |
| Shrinkage | <1 | <1 | 11 MD, | 8 | 0 | 40 | 15 | 20 | −2.5 MD, | <5 | <5 | 0 | −1 MD, | 0 |
| Value (%; | | | 4 TD | | | | | | −1 TD | | | | 2 TD | |
| MD = TD | | | | | | | | | | | | | | |
| unless noted) | | | | | | | | | | | | | | |
| Bond | 1100 | 475 | 1121 | 325 | 650 | 750 | 125 | 650 | NA | CNS* | 1151 | CNS* | CNS* | CNS* |
| Strength | | | | | | | | | | | | | | |
| (inner tie | | | | | | | | | | | | | | |
| layer; | | | | | | | | | | | | | | |
| peak; g/inch) | | | | | | | | | | | | | | |
| Seal Strength | 3800 | 1750 | 8618 | 2994 | 3000 | 4100 | 1701 | 4309 | 3000 | 998 | 6350 | 4536 | 4309 | 4082 |
| (seal to self | | | | | | | | | | | | | | |
| at 300 F. | | | | | | | | | | | | | | |
| 1 sec | | | | | | | | | | | | | | |
| 40 psi; peak; | | | | | | | | | | | | | | |
| g/inch) | | | | | | | | | | | | | | |
| Flex crack | 3 | 20 | 13 | 0 | 50 | 0 | 0 | 0 | 13 | 6 | 0 | 11 | 17 | 18 |
| (average | | | | | | | | | | | | | | |
| pinholes | | | | | | | | | | | | | | |
| after 2025 | | | | | | | | | | | | | | |
| flexes) | | | | | | | | | | | | | | |
| Instron slow | 3 | 2 | 5.17 | 9 | 5.7 | 6.1 | 4.7 | 8 | 1.3 | 6.5 | 8 | 3.9 | 3.3 | 4.25 |
| puncture (lbs) | | | | | | | | | | | | | | |
| Instron slow | 1.5 | 1.6 | 2.6 | 5.5 | 3.0 | 3.5 | 4.7 | 7.0 | 0.7 | 4.3 | 4.0 | 1.3 | 0.9 | 0.9 |
| puncture | | | | | | | | | | | | | | |
| (lbs per mil) | | | | | | | | | | | | | | |
| Dart drop | 29 | 21 | 27 | 78 | 50 | 77.7 | 47 | 57 | 11 | 58 | 28 | 14 | 11 | 18 |
| (lbs) | | | | | | | | | | | | | | |
| Dart drop | 14.5 | 16.8 | 13.5 | 47.3 | 26.3 | 44.4 | 47.0 | 49.6 | 6.3 | 38.7 | 14.0 | 4.7 | 3.1 | 4.0 |
| (lbs per mil) | | | | | | | | | | | | | | |

*Given the ASTM protocol, access to the given bond was not gained.

In regards to the package 70 (FIG. 4) packaging configurations, so samples 9 and 12-14, an additional three properties, which are indicative of resistance to puncture and hole development upon flexing, can be important to the present invention and distinguish the inventive film from the noted prior art films, especially with the invention's preferred thin-ness as compared to thicker prior art films. One optional property is flex crack resistance, and this can be determined as known by one of ordinary skill in the art, and preferably by using the following test: Gelbo flex via ASTM F392-93 (rev. 2008). Another optional property is puncture resistance, and this can be determined as known by one of ordinary skill in the art, and preferably by using one or both of the following tests: dart drop via ASTM D7192-10 and slow puncture via ASTM F1306-90.

Each and every document cited in this present application, including any cross referenced or related patent or application, is incorporated in this present application in its entirety by this reference, unless expressly excluded or otherwise limited. The citation of any document is not an admission that it is prior art with respect to any embodiment disclosed in this present application or that it alone, or in any combination with any other reference or references, teaches, suggests, or discloses any such embodiment. Further, to the extent that any meaning or definition of a term in this present application conflicts with any meaning or definition of the same term in a document incorporated by reference, the meaning or definition assigned to that term in this present application governs.

The present invention includes the description, examples, embodiments, and drawings disclosed; but it is not limited to such description, examples, embodiments, or drawings. As briefly described above, the reader should assume that features of one disclosed embodiment can also be applied to all other disclosed embodiments, unless expressly indicated to the contrary. Unless expressly indicated to the contrary, the numerical parameters set forth in the present application are approximations that can vary depending on the desired properties sought to be obtained by a person of ordinary skill in the art without undue experimentation using the teachings disclosed in the present application. Modifications and other embodiments will be apparent to a person of ordinary skill in the packaging arts, and all such modifications and other embodiments are intended and deemed to be within the scope of the present invention.

What is claimed is:

1. A multilayer packaging film process for forming a multilayer packaging film for use as a “deli pack” package comprising:
coextruding each layer positioned relative to each other layer in the following sequential order to form a multilayer packaging film: (a) an exterior layer comprising a member from the group comprising polyamide, polypropylene and polyethylene, (b) a first tie layer, (c) a first inner polyamide layer, (d) a barrier layer, (e) a second inner polyamide layer, (f) a second tie layer and (g) an interior layer of sealant material;
forming the multilayer packaging film to a thickness of from 0.50 mil to 3.0 mil;
imparting a Shrinkage Value of no more than five percent to the multilayer packaging film; and
imparting a One-percent Secant Modulus of from about 100,000 psi to about 160,000 psi to the multilayer packaging film.

2. The multilayer packaging film process of claim 1, further comprising adhering the second inner polyamide layer to the interior layer with a Bond Strength of at least 250 g/inch for the multilayer packaging film.

3. The multilayer packaging film process of claim 1, wherein the thickness of the multilayer packaging film is from about 0.75 mil to about 1.75 mil.

4. The multilayer packaging film process of claim 1, wherein the thickness of the multilayer packaging film is from about 1.25 mil to about 2.5 mil.

5. The multilayer packaging film process of claim 1, wherein the barrier layer of the multilayer packaging film comprises EVOH.

6. The multilayer packaging film process of claim 1, further comprising forming the “deli pack” package with the multilayer packaging film by sealing the interior layer to itself.

7. The multilayer packaging film process of claim 6, further comprising adhering the second inner polyamide layer to the interior layer with a Bond Strength greater than a Seal Strength of the interior layer sealed to itself.

8. The multilayer packaging film process of claim 1, wherein at least one of the imparting steps comprises biaxially orienting the multilayer packaging film.

9. The multilayer packaging film process of claim 1, wherein at least one of the imparting steps comprises annealing the multilayer packaging film.

10. The multilayer packaging film process of claim 1, wherein both imparting steps comprise biaxially orienting the multilayer packaging film and annealing the multilayer packaging film.

11. The multilayer packaging film process of claim 10, wherein the steps of coextruding, biaxially orienting and annealing the multilayer packaging film occur in a continuous in-line process.

12. The multilayer packaging film process of claim 1, comprising forming the multilayer packaging film with a triple bubble process.
